(19) United States
(12) Patent Application Publication
(10) Pub. No.: US 2018/0195250 A1
(43) Pub. Date: Jul. 12, 2018

(54) MODULAR OFFSHORE WIND TURBINE FOUNDATION AND MODULAR SUBSTRUCTURE WITH SUCTION CAISSONS

(71) Applicant: Charles W. NELSON, New Orleans, LA (US)

(72) Inventor: Charles W. NELSON, New Orleans, LA (US)

(21) Appl. No.: 15/865,050

(22) Filed: Jan. 8, 2018

Related U.S. Application Data
(60) Provisional application No. 62/542,650, filed on Aug. 8, 2017.
(60) Provisional application No. 62/443,430, filed on Jan. 6, 2017.

(51) Int. Cl. E02D 27/52; E02D 27/42; F03D 13/10; F03D 13/20; F03D 13/25

(52) U.S. Cl. CPC E02D 27/52; E02D 27/425; E02B 2017/006; F03D 13/22; F03D 13/25; F03D 13/10

(57) ABSTRACT

The present invention relates to an offshore wind turbine support system and method of installation, where the support system is comprised of two structures, an upper frame lattice structure, and a lower foundation structure that has a plurality of supports embedded in the sea floor, with sleeves of varying length protruding from the supports, such that the top of each sleeve in each foundation structure is about at the same distance below sea level as the top of each sleeve in all other foundation structures of the system.

### CROSS-REFERENCE TO RELATED APPLICATIONS

The following related patent applications are hereby incorporated herein by reference: U.S. Provisional Patent Application Ser. No. 62/443,430, filed 6 Jan. 2017; U.S. Provisional Patent Application Ser. No. 62/542,650, filed 8 Aug. 2017; and priority of these applications is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to a wind turbine foundation and substructure and method of installation. More particularly, the present invention relates to a two-piece design for an offshore wind turbine steel substructure and foundation and method of installation.

### 2. General Background of the Invention

The present invention relates to a wind turbine foundation and substructure and method of installation. More particularly, the present invention relates to a two-piece design for an offshore wind turbine steel substructure and foundation and method of installation.

Present jacket installation practice in Europe involves a structural steel template used to drive four pin piles at each jacket location. Once the pin piles are driven into place, the template is removed, at which point a serially fabricated jacket substructure can be simply stabbed into the pin piles and subsequently grouted in place. This current practice of jacket installation in Europe was the inspiration behind a new design (the present invention).

For information about suction cassions, see for example http://www.sptoffshore.com/

The following patent documents are incorporated herein by reference:
U.S. Pat. Nos. 3,535,884; 4,511,288; 6,719,496; 7,075,189; 7,530,780; 8,118,538;
US Patent Application Publication Nos.: 2005/0286979; 2014/0115987; 2015/0322642; 2017/0138351; and
Other Patent/Publication Nos.: WO2015/152826; WO2010059489; WO2010144570; EP2440710.

### BRIEF SUMMARY OF THE INVENTION

The present invention relates to a wind turbine foundation and substructure and method of installation. More particularly, the present invention relates to a two-piece design for an offshore wind turbine steel substructure and foundation and method of installation that could afford a step-change reduction in the levelized cost of offshore wind energy at suitable locations world-wide.

### BRIEF DESCRIPTION OF THE SEVERAL VIEWS OF THE DRAWINGS

For a further understanding of the nature, objects, and advantages of the present invention, reference should be made to the following detailed description, read in conjunction with the following drawings, wherein like reference numerals denote like elements and wherein:

FIG. 1 is a partial top view of a preferred embodiment of the present invention;

FIG. 2 is a partial top view of an alternative embodiment of the apparatus of the present invention;

FIG. 3 is a side, elevation view of a preferred embodiment of the apparatus of the present invention and illustrating a preferred method of assembly or installation;

FIG. 4 is a side, elevation view of a preferred embodiment of the apparatus of the present invention;

FIG. 5 is a side, elevation view of preferred embodiments of the apparatus of the present invention showing wind turbine foundations located at differing sea bed elevations;

FIG. 6 is a perspective view of a preferred embodiment of the apparatus of the present invention;

FIG. 7 is a partial top view of several lower foundation structures of a preferred embodiment of the present invention on a barge prior to installation;

FIG. 8 is a side, elevation view of preferred lower foundation structure embodiments of the present invention;

FIG. 9 is a partial top view of a preferred embodiment of the upper frame lattice structure of the present invention;

FIG. 10 is a side, elevation view of a preferred embodiment of the upper frame lattice structure of the present invention;

FIGS. 11 and 12 are side, elevation views of a preferred embodiment of the apparatus of the present invention undergoing installation, and showing barges with cranes making the installation;

FIG. 13 is a side, elevation view of a preferred embodiment of the apparatus of the present invention showing a typical installation with three (3) apparatuses as installed in varying water depth; and

FIG. 14 is an elevation view of a preferred embodiment of the apparatus of the present invention and showing a preferred method of installation.

### DETAILED DESCRIPTION OF THE INVENTION

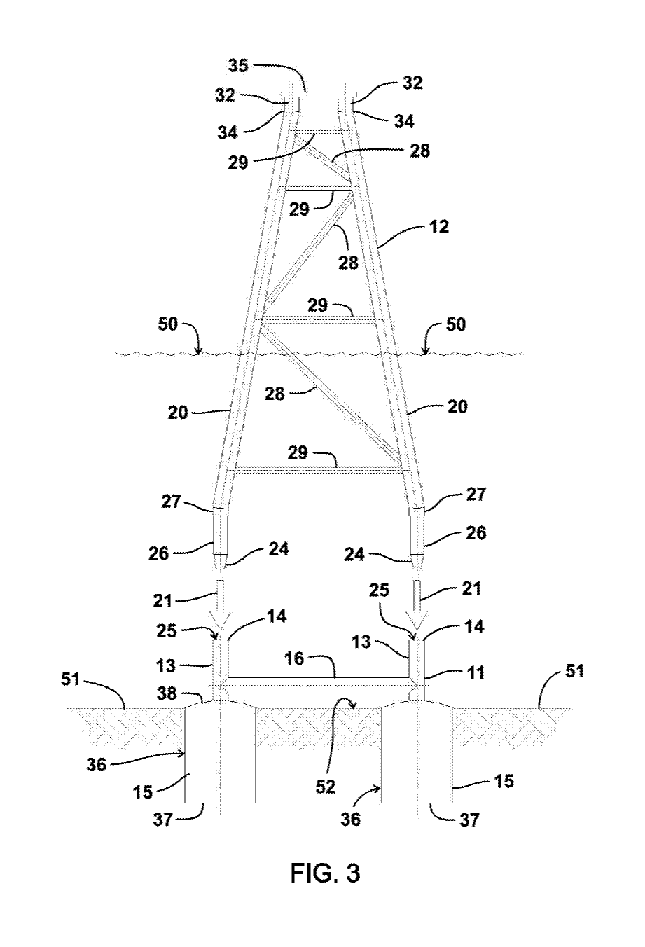

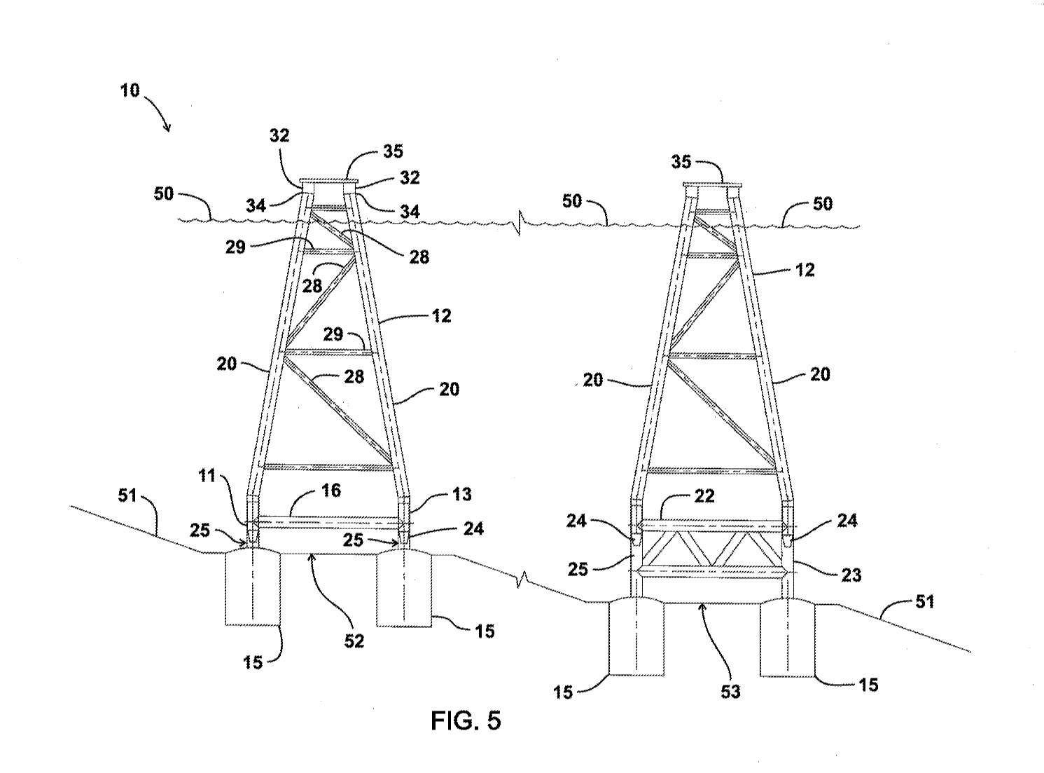

The present invention relates to a wind turbine foundation and substructure and method of installation. More particularly, the present invention relates to a uniquely configured design for an offshore wind turbine steel substructure and foundation and method of installation that could afford a step-change reduction in the levelized cost of offshore wind energy at suitable locations world-wide. In FIGS. 5-6 and 11-14, wind turbine foundation and substructure/foundation apparatus is designated generally by the numeral 10. The method of the present invention is illustrated in FIGS. 3-14.

In one embodiment, the wind turbine foundation apparatus 10 of the present invention is preferably comprised of two structures (lower foundation 11 and tower or upper foundation 12) when assembled. The two structures, or pieces, preferably include an upper tower structure 12 and a lower foundation structure 11 that receives and connects to the upper structure 12. Upper foundation 12 supports wind turbine 60 preferably upon pedestal, mounting plate or upper frame 35.

FIG. 3 shows a preferred embodiment of the present invention with upper structure 12 having stab portions or fittings 24 at its base that will fit into sockets 25 of lower foundation 11. Preferably on top of stab portions 24 of upper structure 12 are vertical sections 26 that connect to inclined members 20 preferably via a coupler 27. Preferably at the top of inclined members 20 are vertical sections 32 that preferably connect to legs 20 with a mitre weld 34. In a preferred embodiment, pedestal 35 sits atop vertical sections 32.

In one embodiment, the present invention is preferably comprised of a plurality of upper towers, space-framed lattice structures or upper foundations 12, each received in a foundation structure 11, wherein the upper structures 12 can preferably be interchangeable and of a substantially uniform size (e.g., for mounting on a selected foundation 11).

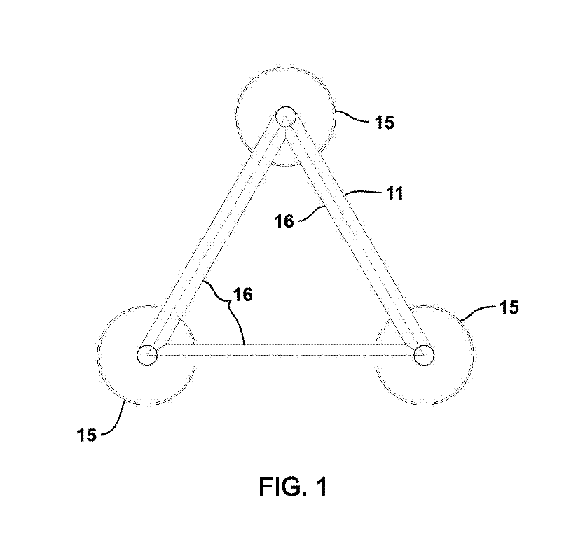

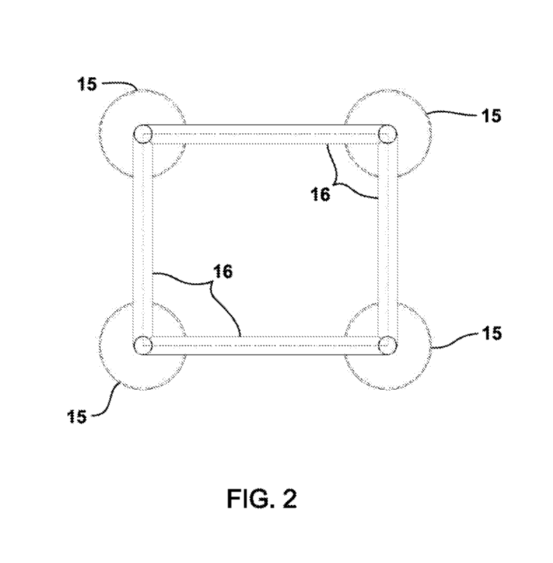

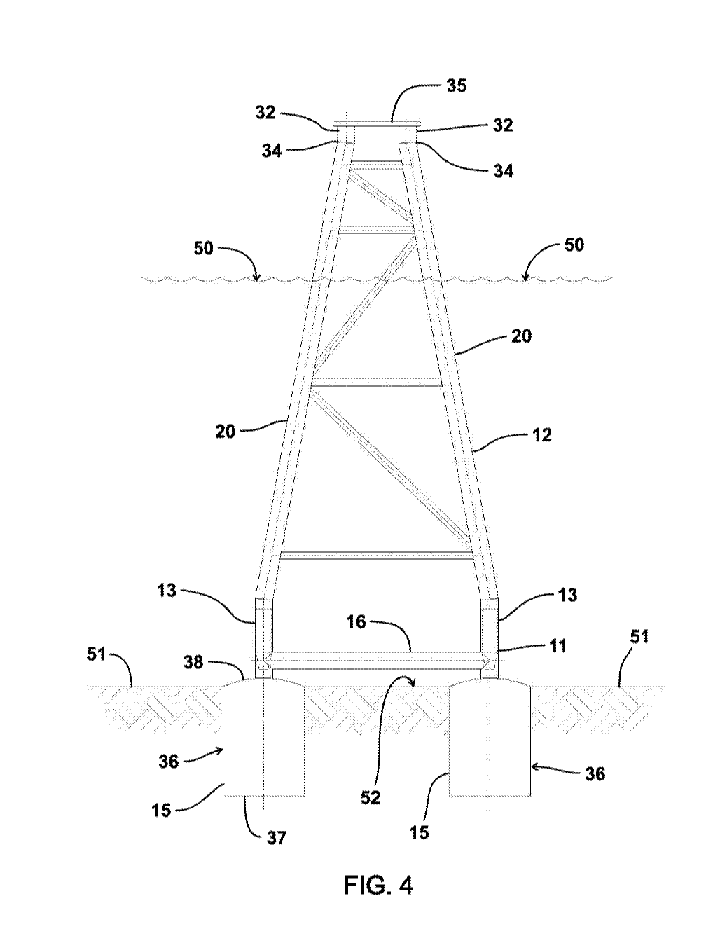

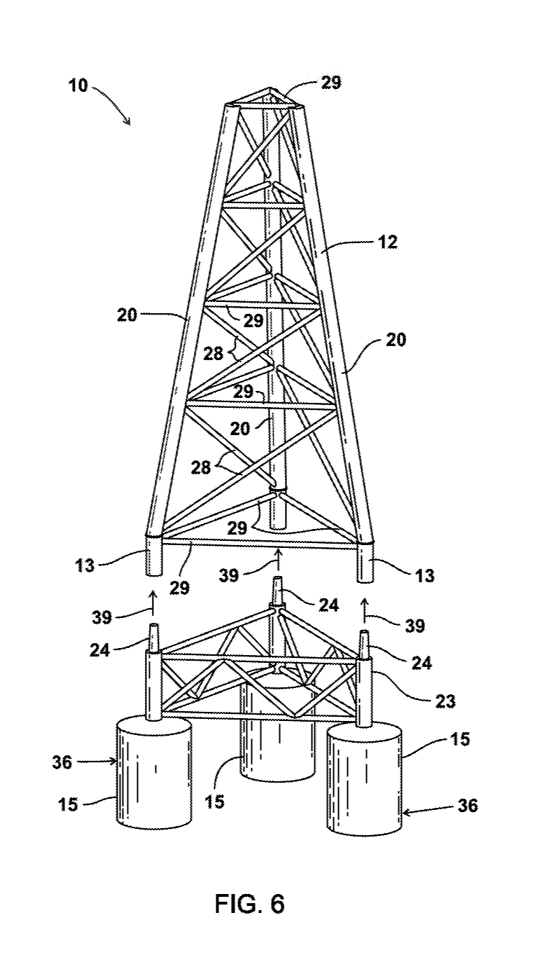

Rather than driven pin piles that are present in the prior art, one embodiment of the present invention preferably has a lower foundation structure 11 with multiple (preferably three) footings 15 (see FIGS. 1 and 6) that are structurally interconnected preferably by steel cross-braces 16. In one embodiment of the present invention, the footings 15 are preferably suction-caissons. In another embodiment of the present invention, the lower foundation structure 11 preferably has three (3) or four (4) footings 15 (see FIGS. 1-2), which are preferably suction-caissons, and that are structurally interconnected preferably by steel cross-braces 16. In another embodiment of the present invention, the lower foundation structure 11 preferably can have more than four footings 15. In one embodiment, the lower structure 11 preferably has a vertical leg 13 that has a socket 25 for receiving and connecting with a stab-in sleeve 14 emerging from each footing 15. As shown in FIGS. 3-4 and 6, in a preferred embodiment, each footing 15 has upper surface 38, bottom opening 37, and a cylindrically shaped outer surface 36. A preferred method of installation of the present invention preferably includes the support foundation 11 (or 23 or 33) drawn down to its final installation depth below the seabed 51 in the sea floor, then a serially fabricated jacket or tower 12 stabbed into the sleeves 14 (see FIGS. 3-4 and arrow 21) and subsequently connected, preferably by either a mechanical or grouted connection procedure, or a combination of the two (see FIGS. 3, 4, and 11-14). In FIG. 6, stab fittings 24 can be provided on the lower foundation (e.g., lower foundation 23) which fit sockets or hollow bore sections of vertical leg sections 13 (see arrows 39 in FIG. 6).

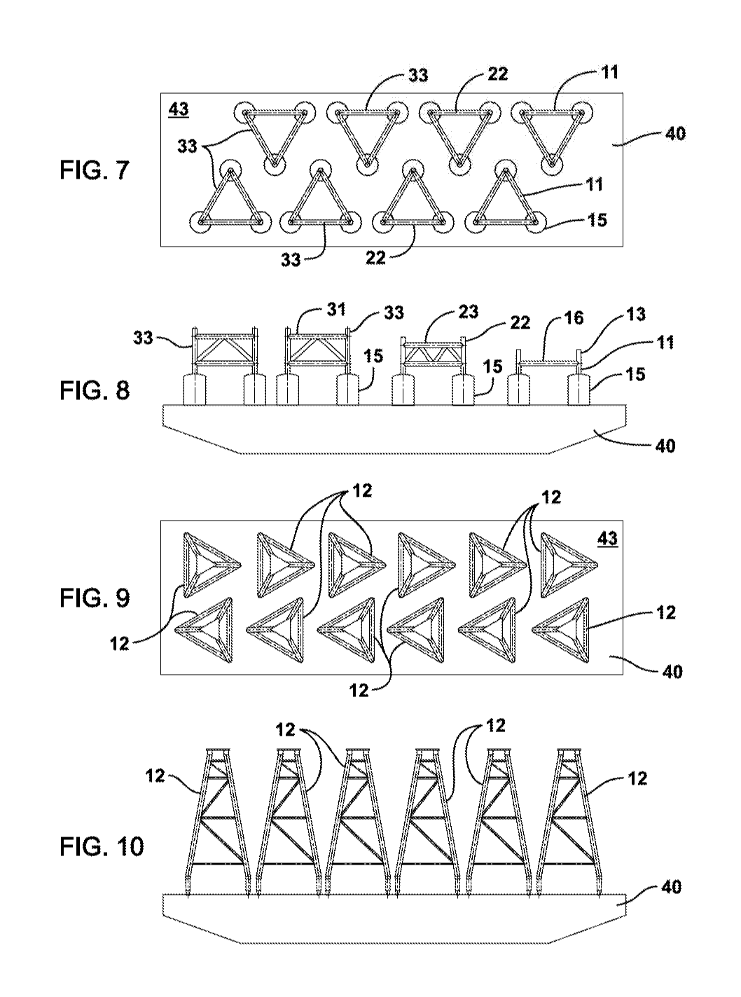

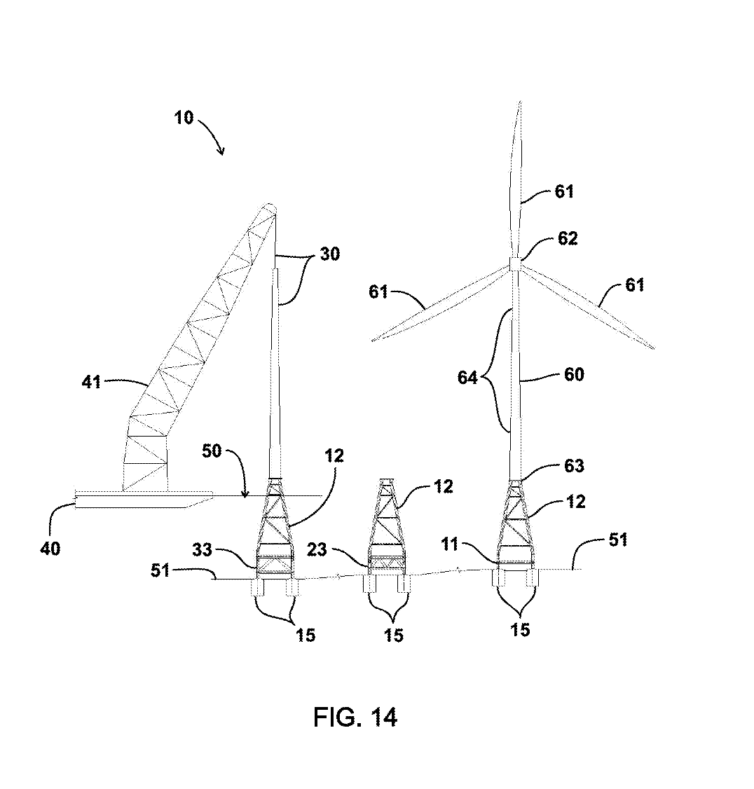

In one embodiment of the present invention, the lower foundation structure 11 preferably has vertical legs 13 of variable height emerging from each support 15 to account for the natural variability of seafloor depth, such that after all the supports 15 have been installed (see FIGS. 5 and 12-13), their stab-in sleeves 14 will preferably all be the same distance below the sea surface. This will enable the upper structure 12 to be substantially identical in design across the entire project, and most likely across the entire fleet of turbines using this new foundation and tower apparatus 10. The apparatus 10 of the present invention will enable major economies of scale and serial production. The above-described system of foundation and substructure installation is illustrated in the FIGS. 7-13. Wind turbines 60 are preferably added to the present invention at pedestal 35 as shown in FIG. 14. FIG. 14 shows base 63 of wind turbine 60 sitting atop pedestal 35 of upper foundation 12. Wind turbine 60 preferably includes a tower 64, the top of which is hub 62 which serves as the connection point for the blades 61 of wind turbine 60. Wind turbine 60 preferably includes at least two blades 61, and FIG. 14 shows wind turbine 60 with three blades 61.

FIGS. 5-14 show the concept of how the top section or tower 12 of the foundation is standard, while the lower structure 11, 23 or 33 is adjustable for water depth (e.g., see seabed elevations 52, 53, 54 in FIGS. 5 and 12-14). The present invention, that preferably uses suction caissons 15, is different from prior art systems which may deal with variation in water depth, but use piles for support, and the driving of piles can disturb whales, turtles, and other marine life. The foundation 11 of the present invention that is preferably a suction caisson foundation does not disturb marine life such as whales, turtles, dolphins, or other species susceptible to noise and vibrations created by the installation of piles. It is the inventor's understanding that when piles are driven in the North Atlantic, a government inspector monitors for certain marine species, and if those certain species are sighted, pile driving is interrupted. Since monitoring is done visually, pile installation can only be done during daylight hours, and consequently, expensive offshore equipment is idled at night.

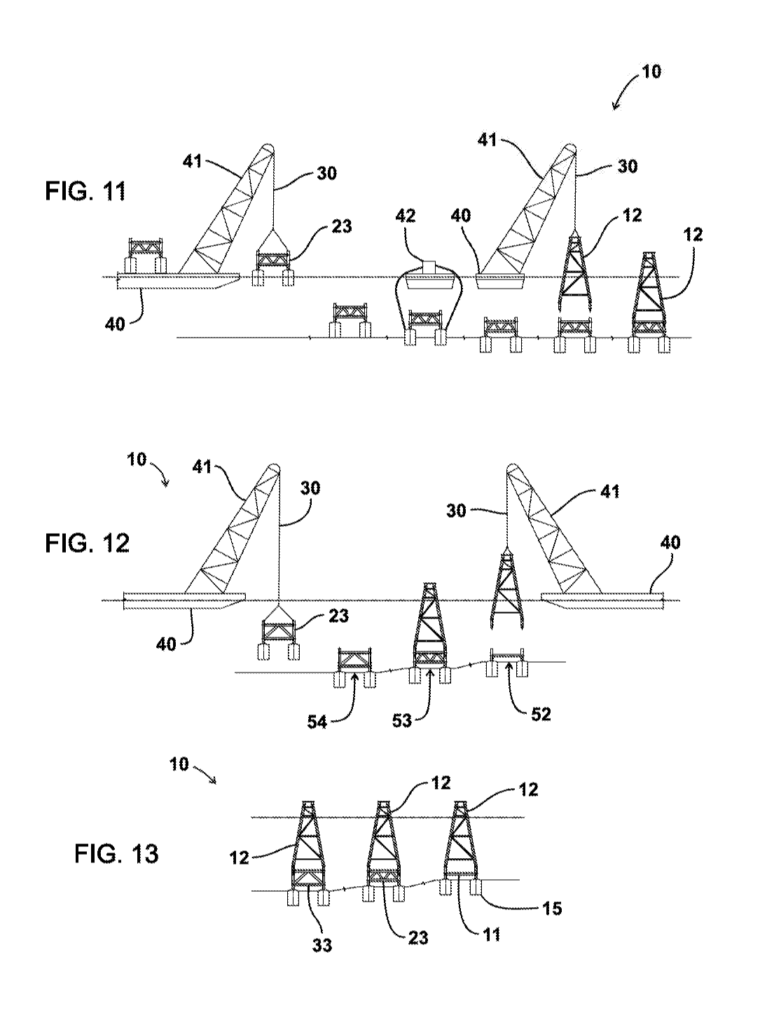

By having an adjustable height lower structure 11, 23, 33 (see FIGS. 8 and 11-13) and a fixed height upper structure 12 (see FIG. 10), smaller lift equipment (30, 40, 41) may be used to install each structure 11, 12, 23, 33. Since big offshore installation equipment can cost hundreds of thousands of dollars per day, a project should benefit from being able to use smaller, less expensive equipment. It may be hard to quantify in dollar amounts, but qualitatively, smaller equipment does not cost as much as bigger equipment. FIGS. 7-14 illustrate the use of a crane barge 40 having crane 41 and lift line/rigging 30 to place a selected lower foundation 11, 23 or 33 on seabed 51, while installation into seabed 51 occurs by using a suction apparatus 42 (commercially available) as shown in FIG. 11.

By varying the height of the lower foundations 11, 23, 33 the crane 41 height can be lower thus saving costs. A crane 41 need only be large enough to lift the upper foundation or tower 12 up above deck 43 of barge 40 or water surface 50. For shallower water depth, the same lift equipment 40 could lift the tower 12 while the lower foundation would be the shorter lower foundation 11.

In an example of a preferred installation, there are modular towers 12 of a fixed size, three different modular transition members of a fixed size, and modular footings or suction caissons 15 of a fixed size (or perhaps multiple fixed sizes, depending upon the underwater terrain and/or water depth) (see FIGS. 7-10). For example, in the water off the Atlantic Seaboard of the US, one might have sizes such as follows:
modular towers 12: 30-70 meters; for example, 40 meters, in height; 13-30 meters, for example, 17 meters, along each side at the base; 6-12 meters, for example, 9 meters, along each side at the top;
shortest modular transition members 16: 2-4 meters; for example, 3 meters, in height measured beginning at the top of footing 15;
medium height modular transition members 22: 4-6 meters, for example, 5 meters, in height measured beginning at the top of footing 15;
tallest modular transition members 31: 6-10 meters; for example, 8 meters, in height measured beginning at the top of footing 15;
modular footings or suction caissons 15: on the order of 6 to 8 meters in diameter and 8 to 12 meters in height. Preferably, the modular footings or suction caissons 15 are connected to the modular transition members 16, 22, 31 at the fabrication yard;

Preferably, the height of the supporting deck of the foundation above mean sea level will be dictated by wave climate and tidal variation of the specific location. The distance from mean sea level to the support deck will preferably be as uniform as is practical, likely on the order of less than one-meter variability across the installation, but it might be as much as three meters in some situations.

The basic plan of the present invention is to capture manufacturing efficiencies with a design that has a high degree of standardization. In a preferred embodiment of the present invention, the variability of soil type and water depth will be accommodated by a two-part foundation. The lower section 11, 23, 33 will preferably be the suction caissons 15, connected by either struts or trusses, for example, to make a structure which can be easily fabricated, transported and lifted in to place by smaller marine equipment than has been customarily done. This lower section 11, 23, 33 is preferably designed to adjust for water depth and soil strength, as dictated by the physical location of each tower in the offshore wind farm.

The upper space-frame tower section 12 is preferably designed as a standard height component, such that multiple identical units can be built in an “assembly line” fashion using, for example, identical pieces of structure such as legs 20, horizontal braces 29, diagonal braces 28, deck sections, cathodic protection anodes, grout lines, and possibly access ladders, boat bumpers or other appurtenances. In a preferred embodiment of the present invention, the upper section 12 of each foundation 10 can be built and transported in either a horizontal or vertical position, or both, depending on the preference of the fabricator (see FIGS. 9-10). In a preferred embodiment of the present invention, the lower sections 11, 23, 33 of the foundation 10 and the caissons 15, which are preferably a part of that section, can be built and transported in a vertical position (see FIGS. 7-8). As shown in FIG. 8, an alternative embodiment of the lower structure can be cross-braces with trusses 31.

In a preferred embodiment of the present invention, the present invention can have the following advantages:

1) The caissons 15 and lower sections 11, 23, 33 can be built in one yard, and the upper sections 12 can be built in another. The yard selected for the upper section 12 may require vertical clearance for those sections to be built and transported in a vertical position (see FIG. 10). Mobilizing different yards could lead to project economies and schedule improvement.
2) The lower sections 11, 23, 33 of each foundation 10 can be installed months ahead of the delivery of the upper section 12, again leading to schedule improvement.

### PARTS LIST

The following is a list of parts and materials suitable for use in the present invention and short-hand designations used herein:

| Parts Number | Description |
|---|---|
| 10 | wind turbine foundation and |
| | substructure/foundation and tower apparatus |
| 11 | lower foundation structure section (shortest size) |
| | including footing 15 and transition member 16 |
| 12 | upper foundation structure section/tower |
| 13 | vertical leg |
| 14 | stab-in-sleeve |
| 15 | base footing/support/caisson |
| 16 | transition member - transverse member/cross-brace |
| 20 | column/inclined member/leg |
| 21 | arrow |
| 22 | transition member - cross-braced with trusses |
| 23 | lower support foundation structure section (mid |
| | size) including footing 15 and transition member 22 |
| 24 | frusto conical stab portion/fitting |
| 25 | socket |
| 26 | vertical section |
| 27 | coupler |
| 28 | diagonal beam/brace |
| 29 | horizontal beam/brace |
| 30 | lift line/rigging/lift equipment |
| 31 | transition member - cross-braced with trusses |
| | (tallest size) |
| 32 | vertical section |
| 33 | lower foundation structure section (tallest size) |
| | including footing 15 and transition member 31 |
| 34 | mitre weld |
| 35 | pedestal/mounting plate/upper frame |
| 36 | cylindrically shaped outer surface |
| 37 | bottom opening |
| 38 | upper surface |
| 39 | arrow |
| 40 | barge/crane barge/lift equipment |
| 41 | crane/lift equipment |
| 42 | suction apparatus for installing suction caissons |
| 43 | deck |
| 50 | mean sea level/water surface |
| 51 | sea floor/seabed |
| 52 | first seabed elevation |
| 53 | second seabed elevation |
| 54 | third seabed elevation |
| 60 | wind turbine |
| 61 | blade |
| 62 | hub |
| 63 | base |
| 64 | tower |

All measurements disclosed herein are at standard temperature and pressure, at sea level on Earth, unless indicated otherwise.

The foregoing embodiments are presented by way of example only; the scope of the present invention is to be limited only by the following claims.

1. An offshore wind turbine support structure system comprising:
a) a plurality of lower foundation structures having supports to be imbedded in the sea floor, with sleeves of varying length protruding from the supports, such that the top of each sleeve in each foundation structure is about at the same distance below sea level as the top of each sleeve in all other foundation structures of the system;
b) a plurality of upper space-frame tower structures received in the foundation structures, the upper space-frame tower structures being of a substantially uniform height; and
c) wherein any selected one of the tower structures will fit when connected to any selected one lower foundation structures.

2. An offshore wind turbine system including the support structure system of claim 1 and wind turbines.

3. A method of deploying wind turbines using the system of claim 2 wherein each wind turbine is attached to and supported upon a selected tower.

4. A method of installation of the system of claim 2 comprising:
imbedding the supports of the plurality of foundation structures into the sea floor;
stabbing a serially fabricated jacket substructure into the sleeves; and
connecting the substructure to the foundation structures.

5. The method of claim 4 wherein the substructure is connected to the foundation structures by a mechanical procedure.

6. The method of claim 4 wherein the substructure is connected to the foundation structures by a grouted connection procedure.

7. The method of claim 4 wherein the substructure is connected to the foundation structures by a combination of a mechanical and a grouted connection procedure.

8. The invention of claim 2, wherein the supports include suction caissons.

9. The invention of claim 3, wherein the supports include suction caissons.

10. The invention of claim 4, wherein the supports include suction caissons, and the imbedding is achieved via suction.

11. The invention of claim 5, wherein the supports include suction caissons.

12. The invention of claim 6, wherein the supports include suction caissons.

13. The invention of claim 7, wherein the supports include suction caissons.

14. The invention of claim 8, comprising modular transition members comprising the sleeves.

15. The invention of claim 9, comprising modular transition members comprising the sleeves.

16. The invention of claim 10, comprising modular transition members comprising the sleeves.

17. The invention of claim 11, comprising modular transition members comprising the sleeves.

18. The invention of claim 12, comprising modular transition members comprising the sleeves.

19. The invention of claim 13, comprising modular transition members comprising the sleeves

20. An offshore wind turbine support structure system comprising:
a) a plurality of lower foundation structures having lower footings configured to be imbedded in the sea floor;
b) each lower foundation structure having support members protruding from the footings;
c) a plurality of upper tower structures, each configured to connect with a selected one of said lower foundation structures;
d) upper and lower connecting portions that enable any one of said tower structures to connect with any one of the lower foundation structures; and
e) wherein the lower foundation structures are of various, different overall heights so that a first selected lower foundation structure that has a taller overall height can be placed in a first deeper location while a second selected lower foundation structure that has a shorter overall height can be placed in a second shallow location and wherein adding a tower structure to either said lower foundation structure places the top of the tower structure above sea level.

21. An offshore wind turbine system including the support structure system of claim 10 and a wind turbine mounted upon each said tower structure.

22. A method of deploying wind turbines using the system of claim 21 wherein the wind turbine is mounted to the upper end or top of a said tower.

23. A method of installation of the system of claim 21, wherein the lower footings include suction caissons, comprising:
imbedding the supports of the plurality of foundation structures into the sea floor via suction;
stabbing a serially fabricated jacket substructure into the sleeves; and
connecting the substructure to the foundation structures.

24. The method of claim 23 wherein the substructure is connected to the foundation structures by a mechanical procedure.

25. The method of claim 23 wherein the substructure is connected to the foundation structures by a grouted connection procedure.

26. The method of claim 23 wherein the substructure is connected to the foundation structures by a combination of a mechanical and a grouted connection procedure.

27. The system of claim 21, wherein the lower footings include suction caissons.

28. The invention of claim 27, comprising modular transition members comprising the lower footings.

29. The system of claim 20 wherein the connecting portions include stab fittings and sleeves that engage to form connections between each said lower foundation and each said tower structures.

30. The system of claim 29 wherein each tower has multiple diagonally extending outer legs and mitre connections between each outer leg and each lower foundation structure.

31. (canceled)
